(19) United States
(12) Patent Application Publication
(10) Pub. No.: US 2003/0210944 A1
(43) Pub. Date: Nov. 13, 2003

(54) Arts and crafts tool for applying pigment from naturally pigmented solid materials

(76) Inventor: Emory J. Clark, Airway Heights, WA (US)

Correspondence Address: WELLS ST. JOHN P.S., 601 W. FIRST AVENUE, SUITE 1300, SPOKANE, WA, 99201, US

(21) Appl. No.: 10/143,327

(22) Filed: May 9, 2002

(51) Int. Cl. A47L 13/26; B05D 1/28; A47L 13/30

(52) U.S. Cl. 401/139; 427/429

(57) ABSTRACT

An art and craft tool for spreading pigment from a naturally pigmented solid material to onto a workpiece surface, comprising a tool frame; a base surface on the tool frame; a material holder projecting outwardly of the base surface and configured to releasably mechanically secure a naturally pigmented solid material adjacent to the base surface, against slippage with respect to said base surface; wherein such naturally pigmented solid material secured by the holder may be pressed against a workpiece and rubbed such that pigment from the material is pressed by the base surface against the workpiece and pigment from the pigmented material is deposited onto the workpiece.

### CROSS REFERENCE TO RELATED APPLICATION

This application is an original U.S. Patent Application.

### TECHNICAL FIELD

The present invention relates to arts and crafts and more particularly to application of pigments from naturally occurring solid materials to a workpiece.

### BACKGROUND OF THE INVENTION

Most if not all natural occurring solid materials include a pigment. Plants typically include pigment that may be relatively easily transferred from the plant form to another surface.

Grass stained knees are a good example of pigment transfer from grass (a solid, naturally pigmented material), to skin or clothing. The pigment transfer is the effect of pressure and sliding engagement between the workpiece (pants or skin) and pigmented material (grass). This type of pigment transfer is usually not intentional or desired.

Despite the above, controlled application of pigment over selected surfaces is very desirable, and industries have been developed to fulfill the need. However, development has been toward combination of natural or synthetic pigments with fluid carriers such as paints, inks and stains; or pigment with solid manufactured carriers as in colored pencils, crayons, chalks and the like. Attempts are often made to produce such pigments in combinations that will closely resemble naturally occurring colors.

The present invention offers a novel arts and craft tool and process by which pigment from naturally occurring solid materials may be transferred onto a desired surface.

### BRIEF DESCRIPTION OF THE DRAWINGS

Preferred embodiments of the invention are described below with reference to the following accompanying drawings.

FIG. 1 is a side elevation view of an exemplary art and craft tool embodying a preferred form of the present invention that may be used for transferring pigment from a solid material to a workpiece;

FIG. 2 is a top plan view of the FIG. 1 example;

FIG. 3 is a bottom plan view of the FIG. 1 example;

FIG. 4 is a sectioned view taken along line 4-4 in FIG. 5, of another exemplary pigment transfer tool using a pointed material holder and adapted to receive a rounded material holder;

FIG. 5 is an exploded elevational view of the tool shown sectioned in FIG. 4;

FIG. 6 is an elevational view of the FIG. 5 tool assembled with the rounded material holder in place;

FIG. 7 is an elevational view of another exemplary tool including rotatable holder surfaces;

FIG. 8 is a plan view or the FIG. 7 holder example;

FIG. 9 is an elevation view of a tool with a burnisher;

FIG. 10 is an elevation view of a tool with a rotatable surface at one end and a burnisher at an opposite end;

FIGS. 11-15 are detail views of exemplary holder surfaces; and

FIG. 16 is a perspective view showing an exemplary tool in operation;

FIG. 17 is a diagrammatic view of another alternate form of tool;

FIG. 18 is a detail view of an exemplary holder; and

FIG. 19 is a fragmented view of another exemplary holder

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

Before discussing details of preferred elements of the present invention, general aspects will be discussed below. More detailed discussion of various preferred elements will then follow.

As used herein, the term “naturally pigmented solid materials” may be understood to include but not be limited to such naturally occurring pigmented solid materials such as leaves, petals, blades, needles and other foliage, stems, buds, bark, fronds; fruit, vegetable or nut skins or rinds; and other relatively solid naturally occurring, preferably biological materials that are pigmented and from which the pigment may be released by pressing or rubbing the material against a workpiece. The workpiece may be fabric, paper, ceramic, wood, polymer, or any other surface that is capable of being colored with pigment from the pigmented material.

In one aspect, a pigment applying tool 10 is provided, for spreading pigment from a naturally pigmented solid material to a workpiece W. The tool includes a tool frame 12 and a base surface 14. A solid material holder 16 projects outwardly of the base surface 14 and is configured to releasably and mechanically secure a solid pigmented material M adjacent to the base surface 14, against slippage with respect to said base surface 14. The naturally pigmented solid material M, which is secured by the holder 16, may be pressed against a workpiece W in such a manner that pigment from the material is pressed by the base surface against the workpiece and pigment from the pigmented material is deposited onto the workpiece.

Another aspect includes a process for applying pigment from a solid naturally pigmented material M to a workpiece W, comprising providing a tool frame 12 with a base surface 14 and a material holder 16 that is configured to secure a solid naturally pigmented material M against slippage along the base surface. The process further includes securing the solid naturally pigmented material M to the material holder; and pressing the secured pigmented material M against the workpiece W such that pigment from the material M is transferred to the workpiece W

A further aspect involves an arts and crafts process for applying pigment from a naturally pigmented solid material M to a workpiece surface W by obtaining a naturally occurring solid pigmented material M and placing the pigmented material M against the workpiece surface W, and pressing a base surface 14 of a hand held tool 10 against the pigmented material and workpiece surface W with sufficient force to cause a transfer of pigment from the material M to the workpiece surface W.

Examples of the art and craft tool are illustrated in the drawings to identify various forms that may be produced. It is pointed out however, that other forms could be envisioned and fall within the scope of the appended claims from the teachings herein.

Preferred forms of the present tool 10 include a form of the material holder 16. In general terms, the holder 16 projects outwardly of the base surface 14, whether it be integral with the tool frame or attached thereto. The preferred holder 16 is configured to releasably secure a solid naturally pigmented material (for example a leaf) against slipping motion with respect to the base surface 14.

It is preferred that the holder 16 project from the base surface 14 by a distance within a range of approximately 0.016 and 0.06 inches. Preferably, the selected distance is no greater than approximately 0.06 inches. The distance is selected so that a naturally pigmented solid material such as a leaf, flower petal, etc, may be partially but not fully penetrated or at least indented and mechanically held along one side surface of the material M by the holder 16 to prevent slippage between the material and base surface. The holder 16 thus leaves the opposite, exposed surface of the solid pigmented material to be pressed against the workpiece for pigment transfer. Holder 16 preferably secures the material without full penetration through the material so that little if any engagement will occur between the holder and workpiece when the pigmented material is pressed against the workpiece to achieve pigment transfer.

The preferred holders include multiple projections that are formed as hooks, spikes, teeth, roughened surfaces, granular material, or other high friction surfaces that will afford a releasable mechanical connection to a solid naturally pigmented material. The material thus attached to the tool will not readily slip along the base surface 14, but will slide over most workpiece surfaces and remain stationary relative to the tool. Further, the holder 16 secures the material such that insignificant if any engagement will occur between the holder and workpiece surface when the pigmented material is pressed to transfer pigment.

The material holder 16 is exemplified in FIGS. 11-13 as a plurality of hook members 50. The hook members 50 project outwardly of the base surface 14 to hooked ends that may be used to slightly penetrate and secure the material M as partially shown in FIG. 12. The hook members may be formed as an integral part of the tool 10 as identified in FIG. 11. Alternatively, the hook members may be attached to the tool by way of adhesive or another appropriate fastening or securing arrangement. In the FIG. 12 arrangement, the material holder 16 may also be releasably attached to the tool and reinforced by the adjacent tool surfaces.

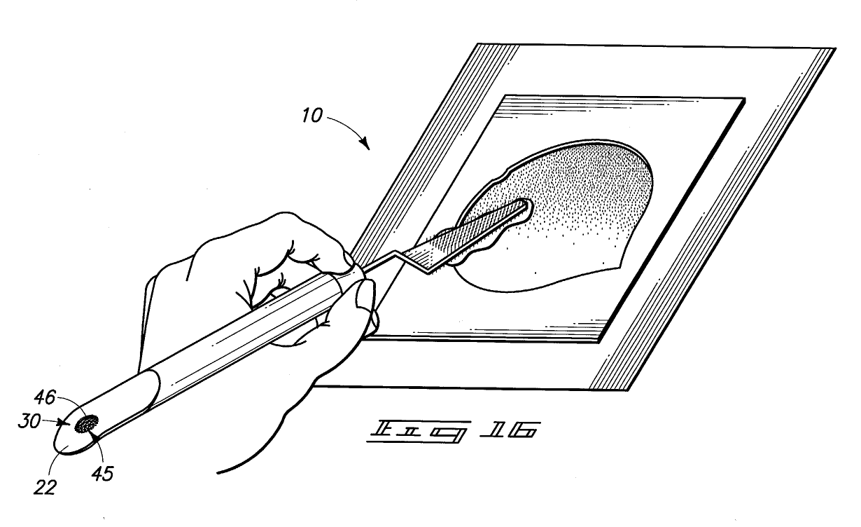

FIG. 13 is representative of a set of hook members 50 that may be individually secured to the base surface 14. This may be accomplished by interference fit between the individual hooks and holes formed in the base surface, spot welding, or by other fastening techniques.

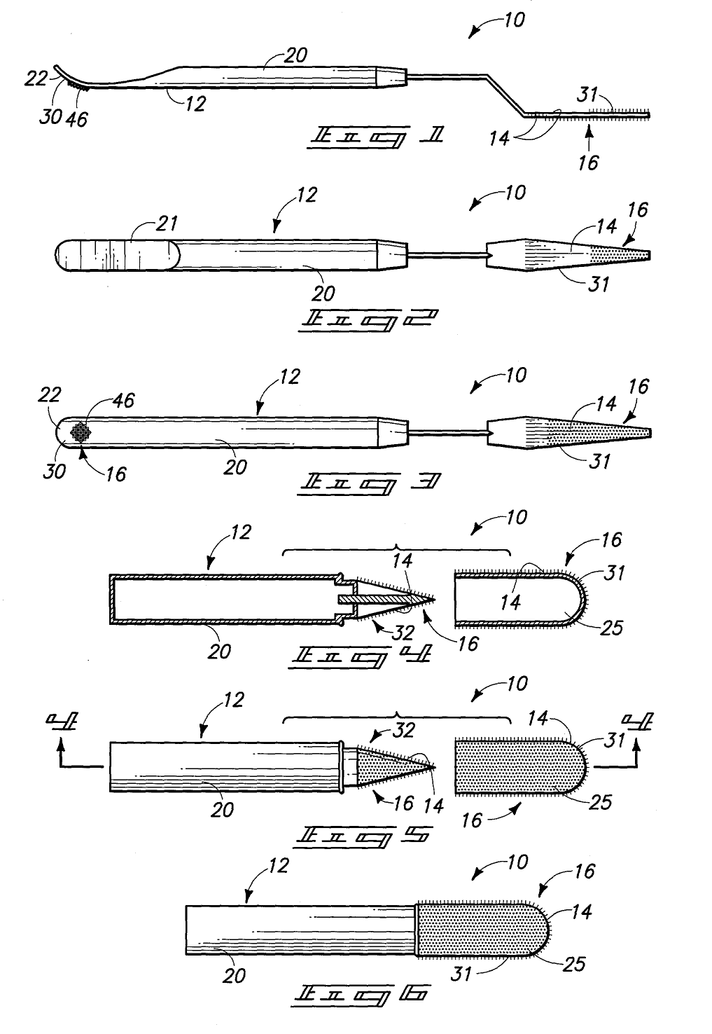

Hook arrangements similar to those exemplified above may be used for the tool embodiments illustrated in FIGS. 1-10, 16 and 17.

Hook type holders might also be used for tool configurations not shown but within the scope of this application. It is preferred that the hook members 50 be slightly flexible to permit resilient bending of the hooked ends during mechanical attachment of the material M, and release of the material once the pigment transfer has been accomplished. To this end, the hooks may be formed of a relatively flexible materials such as an appropriate polymer. The hooks could also be formed of an appropriate metal. Metal hook configurations would be preferred in versions where the individual hooks are mechanically or otherwise affixed to the base surface 14.

In a preferred example, the hook members 50 may be similar if not identical to the hook members of hook and loop fastener materials known under the trademark “Velcro”. It has been found that the small flexible hooks function well to secure naturally pigmented solid materials to the tool. The backing surface of the “Velcro” brand hook material may be reinforced by adjacent surfaces of the tool frame 12.

FIGS. 11 and 15 show another example of the material holder 16. Here, the holder is comprised of a multiplicity of outwardly projecting spikes 51 that may be integral with the tool frame (FIG. 14) or attached (FIG. 15) to the tool. The integral spikes 51 as exemplified in FIG. 14 may be produced by injection molding, casting, machining, or other appropriate processes. The individual spikes shown in FIG. 15 may be mechanically, electrically, or chemically secured to the base surface 14.

A still further example of the material holder 16 is identified in FIG. 19. Here, an aggregate high friction surface is provided in the form of abrasive granules 53 that may be directly secured to the tool or to a backing surface as illustrated. Another form of roughened or abrasive surface may be provided in the form of a toothed or milled surface 46 as shown in FIGS. 1, 3, and 18. In this configuration, the abrasive or tooth surface configuration may be integrally formed of the tool material by knurling, milling, casting or injection molding the projections in forms similar to that illustrated in FIG. 18 or other configurations that would provide a mechanical engagement between the tool and pigmented material.

The above are examples of various mechanical engagement means for releasably and partially impaling the naturally pigmented solid material. By “partially impaling” is meant to include actual penetration of the material or indentation of the material to secure the material against sliding motion with respect to the adjacent base surface when the tool is used to rub or press the material to transfer pigment.

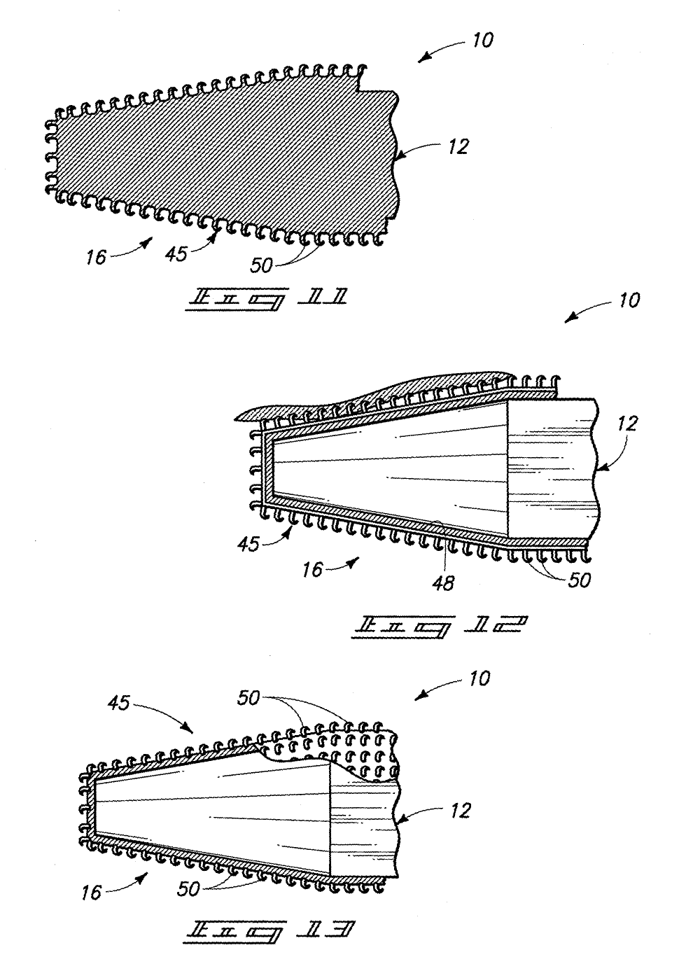

The base surface 14 may be provided in different configurations, several examples of which are illustrated in the drawings. The base surface may be integrated with the tool frame 12 as indicated in FIG. 18, 17, and 11. Alternatively, the base surface 14 may be releasably mountable to the tool frame 12 as indicated in FIGS. 3-6 and 12. Additionally, the base surface may be provided as a flexible base arrangement as shown by the “pallet knife” configuration of FIGS. 1-3, or be movably mounted to the tool frame as indicated by the roller arrangements shown in FIGS. 7 and 8. In the preferred forms, the base surface provides mounting or integrated support for the material holder 16 and, in some embodiments, is actually integrated with the tool frame and holder 16 as may be understood by the configuration exemplified in FIG. 17.

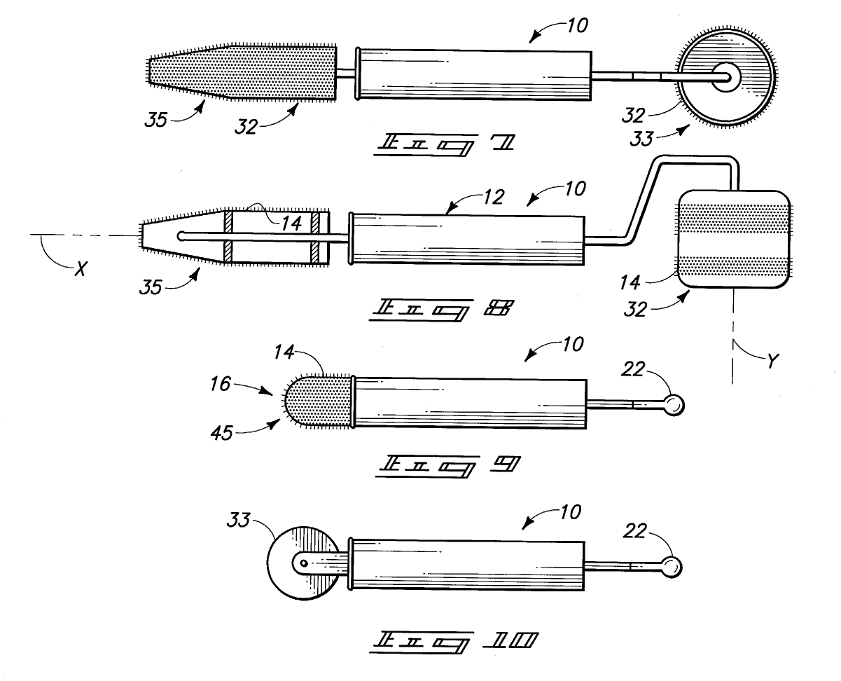

FIGS. 4 and 17 show variations of the socket arrangement, one of which may be slidably received over the tool frame 12, and another to be fitted over a user's finger or thumb. In either instance, the material holder 16 projects outwardly of the base surface 14 and provides the same function as the other exemplified arrangements. The socket 25 may take any appropriate configuration as suggested by the various forms shown in the drawings. For example, the conical configuration shown in FIGS. 4 and 5 could be a replaceable socket configuration, as could the configurations shown by the FIG. 12 example. Cylindrical sleeve configurations could also be provided as suggested in FIGS. 7 and 8 with the base surface being a roller that may be rotatable about an axis Y (FIG. 8) that is angularly oriented with respect to the tool frame 12, or rotatable along an axis X that is substantially co-extensive with the elongated handle.

The tool frame 14, as illustrated in the drawings, may take various forms as well. A rigid elongated handle is shown in FIGS. 1-3 while a shorter hollow handle configuration is shown in FIG. 3-6. Similar handle configurations are shown in FIGS. 7-10 and the socket form of tool frame is indicated in FIG. 17. The objective of all of these configurations is to allow the tool to be hand held and manipulated in such a manner that the naturally pigmented material may be secured on the holder 16 and pressed or rubbed against the workpiece W.

Operation of the invention may be understood in terms of the process for applying pigment from a solid naturally pigmented material M to a workpiece W. The tool frame is obtained with the base surface 14 in a configuration similar or equivalent to the structures illustrated and described herein. The selected solid naturally pigmented material may be secured to the material holder simply by pressing the projections against the material to the point where the projections sufficiently indent or penetrate the material to prevent relative motion or sliding motion between the material and tool. The secured material is then pressed against the workpiece so that pigment from the material is transferred to the workpiece.

In a particular example, let us assume a rose is available and the crafter wishes to produce a rose image on, say, a greeting card. The crafter may select the rose from a special event to add further emotional value to the finished artwork. So in the example, let us assume the rose was collected from a wedding bouquet. The solid pigmented material from the rose may be utilized with the present tool to transfer pigment from the actual rose elements to the surface of the card.

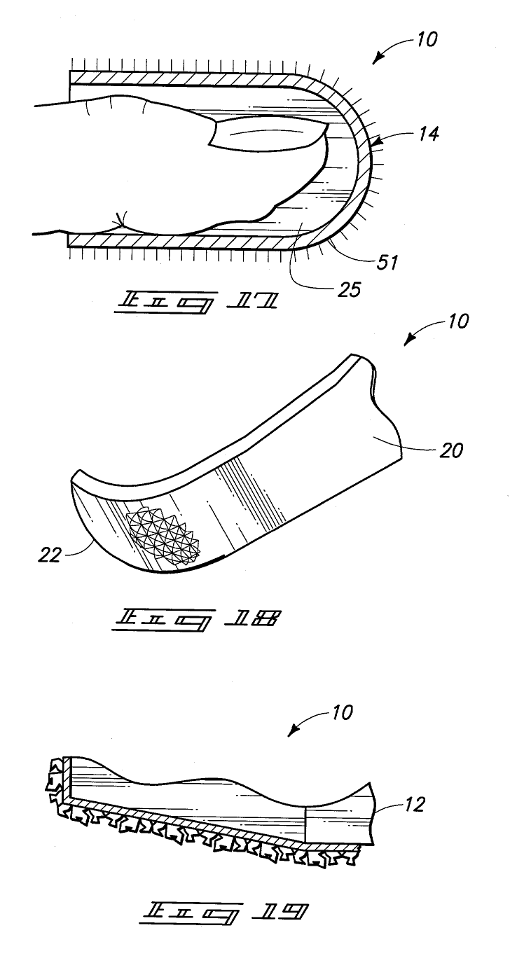

The above may be done as generally illustrated in FIG. 16 by use of stencils, other appropriate masking, or the image may be created entirely by the crafter. In either circumstance, the crafter may produce the rose petals for the image by taking one or more petals from the actual rose and pressing them against the appropriately selected material holder 16. The holder 16 secures the rose petal with the adjacent base surface in position to be pressed against the workpiece, thereby expressing or transferring pigment from the rose petal onto the workpiece surface.

Color transfer may be produced by simply pressing the material downwardly onto the surface, by rubbing the material over the surface, or by performing combination of the two procedures. The coloration or pigment of the rose petal as well as scent may thus be transferred to the workpiece in this manner.

Similarly, should the crafter wish to produce an image of the rose leafs, the actual leaf may be mounted to the holder after removal of the rose petal. The same steps may then be repeated for transferring the green pigment from the rose leaf to the workpiece surface. Thus, an image may be created from actual organic materials by transferring pigment from the solid material directly to the workpiece surface preserving the pigment of the actual rose in an image on the card.

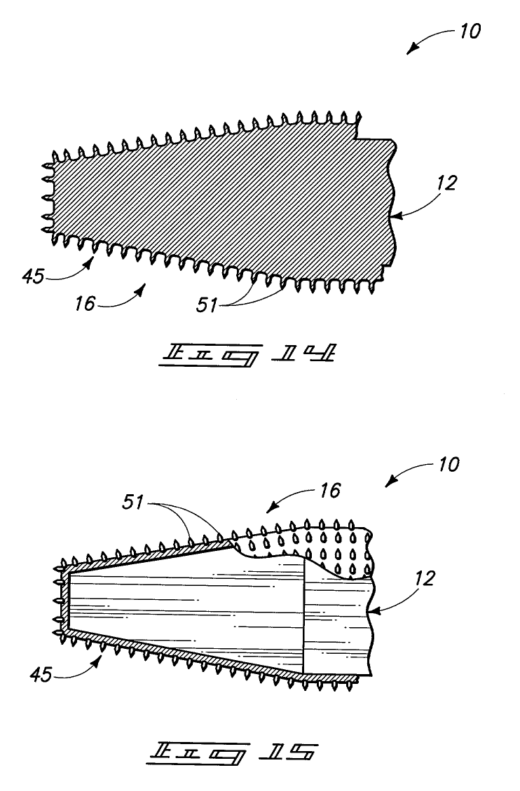

In order to produce highlights or fine definition, the tool arrangement shown in FIG. 10 may be utilized in a process by which pigment may be transferred by obtaining the pigmented material, placing the material against the workpiece surface and pressing the base surface (such as the roller 33 exemplified in FIG. 10 or a burnisher 22 as suggested in FIGS. 9 and 10) against the pigmented material and workpiece with sufficient force to cause transfer of the pigment from the material to the workpiece surface. Fine detail may therefore be applied using pigment from the natural material.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. An art and craft tool for spreading pigment from a naturally pigmented solid material onto a workpiece surface, comprising:
a tool frame;
a base surface on the tool frame;
a material holder projecting outwardly of the base surface and configured to releasably mechanically secure a naturally pigmented solid material adjacent to the base surface, against slippage with respect to said base surface;
wherein such naturally pigmented solid material is sufficiently secured by the holder so that the naturally pigmented solid material may be W pressed against a workpiece and moved relative to the workpiece such that pigment from the material is transferred to the workpiece.

2. The art and craft tool of claim 1 wherein the tool frame is an elongated rigid handle and wherein the base surface and holder are positioned adjacent one end of the handle.

3. The art and craft tool of claim 1 wherein the tool frame is a finger cot including a finger receiving socket.

4. The art and craft tool of claim 1 wherein the base surface is integral with the tool frame.

5. The art and craft tool of claim 1 wherein the base surface is releasably mounted to the tool frame.

6. The art and craft tool of claim 1 wherein the material holder projects from the base surface by a distance not substantially greater than 0.06 inches.

7. The art and craft tool of claim 1 wherein the material holder projects from the base surface by a distance within the approximate range of 0.016 and 0.06 inches.

8. The art and craft tool of claim 1 wherein the base surface is a roller rotatably mounted to the tool frame.

9. The art and craft tool of claim 1 wherein the tool frame is an elongated handle and the base surface is a roller rotatably mounted to the tool frame for rotation about an axis that is angularly offset from the elongated tool handle.

10. The art and craft tool of claim 1 wherein the tool frame is an elongated handle and the base surface is a roller rotatably mounted to the tool frame for rotation about an axis that is substantially co-extensive with the elongated handle.

11. The art and craft tool of claim 1 wherein the holder is comprised of material engaging spikes projecting outwardly of the base surface.

12. The art and craft tool of claim 1 wherein the holder is comprised of a mat of hook members projecting outwardly of the base surface.

13. The art and craft tool of claim 1 wherein the holder is comprised of abrasive grit projecting outwardly of the base surface.

14. The art and craft tool of claim 1 wherein the holder is comprised of a toothed surface formed in the base surface.

15. The art and craft tool of claim 1 wherein the holder is comprised of mechanical engagement means for releasably and partially impaling the naturally pigmented solid material.

16. The art and craft tool of claim 1 wherein multiple base surfaces are provided on the tool frame.

17. The art and craft tool of claim 1 wherein the base surface includes a convex curvature and wherein the holder is disposed along the curvature.

18. An arts and crafts process for applying pigment from a solid naturally pigmented material to a workpiece, comprising:
providing a tool frame;
providing a base surface on the tool frame;
providing a material holder on the base surface, configured to secure a solid naturally pigmented material against slippage along the base surface;
securing a solid naturally pigmented material to the material holder; and
pressing the secured pigmented material against the workpiece such that pigment from the pigmented material is transferred to the workpiece.

19. The process of claim 18 wherein the holder projects outwardly of the base surface; and
securing the pigmented material to the material holder is accomplished by pressing the material holder against the pigmented material such that the holder partially pierces the pigmented material.

20. The process of claim 18 wherein securing the pigmented material is further defined by releasably mechanically securing the pigmented material to the holder.

21. A process for applying pigment from a pigmented material to a workpiece surface, comprising:
obtaining a naturally occurring solid pigmented material;
placing the pigmented material against a workpiece surface; and
pressing a base surface against the pigmented material and workpiece surface with sufficient force to cause a transfer of pigment from the material to the workpiece surface.
